(19) United States
(12) Patent Application Publication
(10) Pub. No.: US 2013/0291984 A1
(43) Pub. Date: Nov. 7, 2013

(54) Insulation Assemblies, Insulated Conduit Assemblies, and Related Methods

(71) Applicant: ARMACELL ENTERPRISE GMBH, Munster (DE)

(72) Inventors: Thomas W. Himmel, Chapel Hill, NC (US); Michelle Lee Moss, Burlington, NC (US); Kartik A. Patel, Chapel Hill, NC (US); Charles M. Princell, Graham, NC (US); Michael J. Resetar, Hillsborough, NC (US)

(73) Assignee: Armacell Enterprise GmbH, Munster (DE)

(21) Appl. No.: 13/798,537

(22) Filed: Mar. 13, 2013

Related U.S. Application Data
(60) Provisional application No. 61/687,882, filed on May 3, 2012.

(51) Int. Cl. F16L 59/02; F16L 59/14

(52) U.S. Cl. CPC F16L 59/02; F16L 59/14
USPC 138/32; 428/172; 428/158; 29/428

(57) ABSTRACT

Embodiments of the present disclosure relate to insulation assemblies that may be wrapped around conduits or other structures to form an in insulated conduit assembly. The insulation assembly may include an outer jacket and a plurality of trapezoidal insulation segments coupled to the inside surface thereof. The trapezoidal insulation segments, which may be formed from closed-cell foam, conform to the shape of the conduit when wrapped thereon. Related methods are also provided.

### CROSS REFERENCE TO RELATED APPLICATION

This application claims priority to U.S. Provisional Patent Application No. 61/687,882, Filed May 3, 2012, which is hereby incorporated herein by reference in its entirety.

### FIELD OF THE DISCLOSURE

The present disclosure relates to insulation for conduits. In particular, the disclosure relates to insulation assemblies that may be wrapped around and attached to oil pipelines or other conduits, and related methods.

### BACKGROUND

One issue of interest in the field of conduits is that of insulating the conduits to reduce heat loss, prevent freezing of the contents therein, and/or achieve other desirable results. For example, in buildings, insulation may be employed around or in air ducts to allow for more efficient transmission of conditioned air through the ducts. Further, insulation may be installed around water pipes to prevent freezing of the water therein, or reduce heat losses from hot water pipes.

In another application, insulation has been applied around oil pipelines in frigid environments, such as the Alaska Pipeline. The insulation is employed to maintain the temperature of the oil therein, such that wax buildup and freezing of moisture in the pipe does not occur. Wax and ice buildup may damage sensors and valves, cause corrosion, clog the pipe, and/or otherwise detrimentally affect use of the oil pipeline.

However, the insulation employed to insulate oil pipelines has hereto suffered from certain defects. By way of example, the Alaska Pipeline employs fiberglass insulation wrapped around the pipe to insulate the pipe. In particular, fiberglass is coupled to a metal shell or jacket, and the assembly is wrapped around the pipe and held in place via bands wrapped around the assembly. However, fiberglass insulation has a tendency to absorb and/or hold water. In this regard, leaks through the outer jacket have resulted in the fiberglass insulation absorbing moisture. The absorbed moisture detrimentally affects the insulating properties of the fiberglass. Further, the water may freeze in the fiberglass, causing damage to the components of the pipeline. Additionally, absorbed water may cause corrosion to the pipeline.

Accordingly, advancements in insulation for conduits configured to transport oil and/or other substances may be desirable.

### SUMMARY OF THE DISCLOSURE

Embodiments of the present disclosure relate to insulation assemblies that may be wrapped around conduits such as oil pipelines to form an in insulated conduit assembly. The insulation assembly may include an outer jacket and a plurality of trapezoidal insulation segments coupled to an inside surface thereof. The trapezoidal insulation segments, which may comprise closed-cell foam, conform to the shape of the conduit when wrapped thereon. Related methods are also provided.

In one aspect of the present disclosure, embodiments of an insulation assembly are provided. In one embodiment the insulation assembly may comprise a jacket defining a first major surface and a second major surface, and a plurality of trapezoidal insulation segments respectively defining a major end surface, a minor end surface, a first angled surface and a second angled surface extending between the major end surface and the minor end surface, a first longitudinal end surface and a second longitudinal end surface. Further, the insulation assembly may include a slip layer coupled to the minor end surface of each of the trapezoidal insulation segments. The major end surface of each of the trapezoidal insulation segments may be coupled to the first major surface of the jacket.

In another embodiment an insulation assembly may comprise a jacket defining a first major surface and a second major surface, and a plurality of trapezoidal insulation segments respectively defining a major end surface, a minor end surface, a first angled surface and a second angled surface extending between the major end surface and the minor end surface, a first longitudinal end surface and a second longitudinal end surface. Further, the insulation assembly may comprise one or more trapezoidal load-bearing segments that are relatively more rigid than the trapezoidal insulation segments and configured to bear at least a portion of a load applied to the insulation assembly. The major end surface of each of the trapezoidal insulation segments may be coupled to the first major surface of the jacket, and the trapezoidal load-bearing segments may be coupled to the first major surface of the jacket.

In another aspect, embodiments of an insulated conduit assembly are provided. In one embodiment the insulated conduit assembly may comprise a conduit, and an insulation assembly wrapped at least partially around the conduit. The insulation assembly may comprise a jacket defining a first major surface and a second major surface, and a plurality of trapezoidal insulation segments respectively defining a major end surface, a minor end surface, a first angled surface and a second angled surface extending between the major end surface and the minor end surface, a first longitudinal end surface and a second longitudinal end surface. The major end surface of each of the trapezoidal insulation segments may be coupled to the first major surface of the jacket, the minor end surface of each of the trapezoidal insulation segments may face the conduit, and the first angled surface and the second angled surface may be configured such that the trapezoidal insulation segments are compressed more proximate the minor end surface than proximate the major end surface.

In another aspect embodiments of a method for insulating a conduit are provided. In one embodiment the method may include providing a conduit and providing an insulation assembly. The insulation assembly may comprise a jacket defining a first major surface and a second major surface, and a plurality of trapezoidal insulation segments respectively defining a major end surface, a minor end surface, a first angled surface and a second angled surface extending between the major end surface and the minor end surface, a first longitudinal end surface and a second longitudinal end surface. The major end surface of each of the trapezoidal insulation segments may be coupled to the first major surface of the jacket. Further, the method may include wrapping the insulation assembly at least partially around the conduit such that the minor end surface of each of the trapezoidal insulation segments faces the conduit and each of the trapezoidal insulation segments is compressed more proximate the minor end surface than proximate the major end surface.

Other aspects and advantages of the present disclosure will become apparent from the following.

### BRIEF DESCRIPTION OF THE DRAWINGS

In order to assist the understanding of embodiments of the disclosure, reference will now be made to the appended drawings, which are not necessarily drawn to scale. The drawings are exemplary only, and should not be construed as limiting the disclosure.

FIG. 1 is a partial perspective view of an insulation assembly according to an example embodiment of the present disclosure;

FIG. 2 is a partial side view of a stack of sheets of insulation material employed to form the trapezoidal insulation segments of the insulation assembly of FIG. 1 according to an example embodiment;

FIG. 3A is a perspective view of an insulation assembly comprising resilient joint members in a planar configuration according to an example embodiment of the present disclosure;

FIG. 3B illustrates the insulation assembly of FIG. 3A in a curved configuration;

FIG. 4 is a perspective view of an insulated conduit assembly comprising the insulation assembly of FIG. 3A according to an example embodiment of the present disclosure;

FIG. 5 is a perspective view of an insulation assembly comprising trapezoidal load-bearing segments according to an example embodiment of the present disclosure;

FIG. 6 is an end view of compressed trapezoidal insulation segments according to an example embodiment of the present disclosure;

FIG. 7 is a perspective view of an insulation assembly wherein contraction of the insulation assembly has caused gaps to form; and

FIG. 8 is a block diagram of a method for insulating a conduit according to an example embodiment of the present disclosure.

### DETAILED DESCRIPTION OF THE PREFERRED EMBODIMENTS

The present disclosure now will be described more fully hereinafter with reference to the accompanying drawings. The disclosure may be embodied in many different forms and should not be construed as limited to the embodiments set forth herein; rather, these embodiments are provided so that this disclosure will satisfy applicable legal requirements. Like numbers refer to like segments throughout. As used in this specification and the claims, the singular forms “a,” “an,” and “the” include plural references unless the context clearly dictates otherwise.

As described herein, embodiments of the disclosure relate to insulation assemblies, insulated conduit assemblies, and related methods. In this regard, insulation may be employed in various applications to insulate conduits (e.g., ducts, pipes, pipelines, tubes, etc.) configured to carry air, water, oil, and/or other fluids. Although insulation presently exists for conduits, Applicants have determined that existing embodiments of insulation may not be suitable for certain applications. For example, fiberglass insulation and open-cell foam may be unsuitable for applications where the insulation is exposed to water. In this regard, it may be possible for the water to travel into the insulation, which may detrimentally affect the insulative properties of the insulation. Further, water infiltration through the insulation may damage the conduit or other components protected by the insulation. Additionally, water which has infiltrated the insulation may freeze in certain applications, which may cause further damage. Accordingly, Applicants herein provide embodiments of assemblies and methods configured to avoid the above-noted deficiencies with respect to existing embodiments of insulation configured for use with conduits.

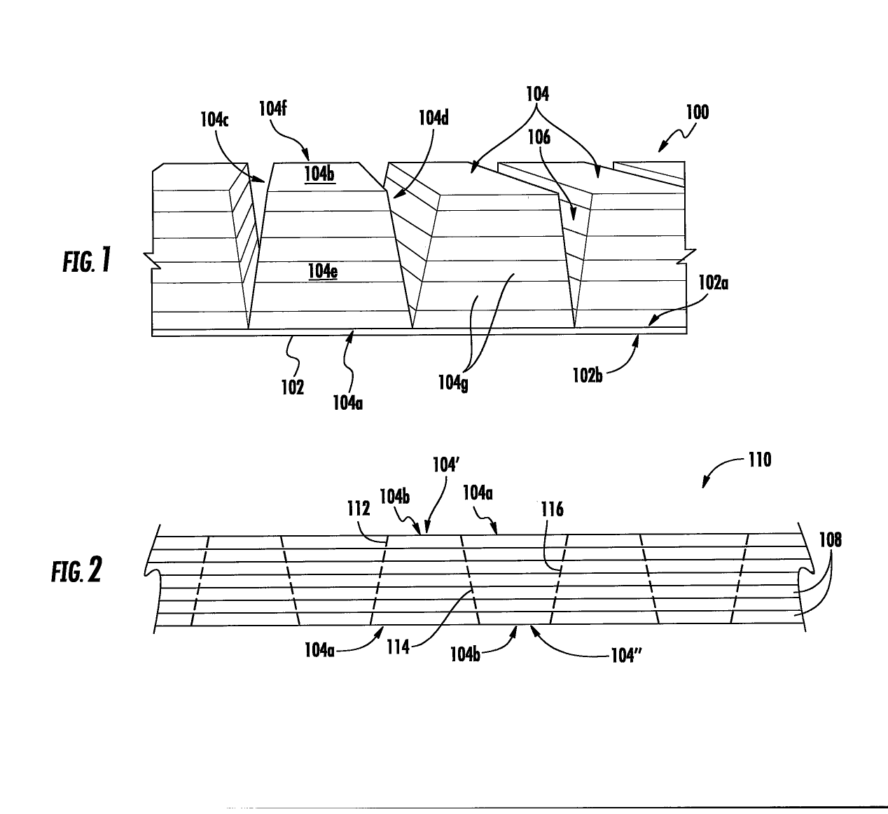

In this regard, FIG. 1 illustrates a partial perspective view of an example embodiment of an insulation assembly 100 according to the present disclosure. The insulation assembly 100 includes an outer shell or jacket 102 defining a first major surface 102a and an opposing second major surface 102b. The jacket 102 may comprise sheet metal (e.g., galvanized or stainless steel), a fiber-reinforced polymer, and/or other materials configured to provide structure to the insulation assembly 100 and/or provide water resistance. In this regard, the jacket 102 may comprise any material suitable for use as a substrate for attachment of segments of an insulation material and that provides sufficient flexibility that allows the insulation assembly 100 to conform to the shape of a conduit.

The insulation assembly 100 further comprises a plurality of insulation segments 104. As described herein, in some embodiments the insulation segments may define a trapezoidal configuration. Accordingly, the insulation segments are generally referred to herein as trapezoidal insulation segments. However, in other embodiments the insulation segments may define other configurations.

Each of the trapezoidal insulation segments 104 may respectively define a major end surface 104a and a minor end surface 104b. The major end surface 104a, which is the larger of the two end surfaces 104a, 104b, is coupled to the jacket 102 at the first major surface 102a thereof. A first angled surface 104c and a second angled surface 104d extend from the major end surface 104a to the minor end surface 104b, which is the smaller of the two end surfaces 104a, 104b. Although the minor end surfaces 104b are illustrated as defining a planar configuration, in other embodiments each minor end surface may define a non-planar configuration such as a concave configuration configured to substantially match the diameter of an object (e.g., a conduit), to which the insulation assembly 100 attaches. In this regard, the trapezoidal insulation segments 104 need not define perfect trapezoidal shapes in all embodiments. Each trapezoidal segment 104 further comprises a first longitudinal end surface 104e and an opposing second longitudinal end surface 104f.

In some embodiments the trapezoidal insulation segments 104 may comprise closed-cell foam. As used herein, “closed-cell foam” refers to a foamed polymeric material having advantageous insulative properties by virtue of the air trapped within the cells of the foam. In one aspect, such insulation materials are in the form of a closed-cell elastomeric foam, such as foam made from a natural or synthetic rubber or blend thereof, or blends of rubber materials with other compatible polymers. The thermal conductivity of closed-cell foam insulation is typically less than about 0.30 BTU·in/hr·ft²·° F. at 75° F. when measured according to ASTM C 335. The water vapor transmission (WVT) of the closed-cell foam will vary depending on the polymer structure of the foam, but is typically less than about 5.0 perm-in, and often less than about 0.10 perm-in for closed-cell rubber materials, when tested according to ASTM E 96, procedure A. Specifications and standards for elastomeric foam insulation materials are set forth in ASTM C534/C534M-11.

The trapezoidal insulation segments described herein may comprise any suitable viscoelastic elastomeric foam materials, including but not limited to, ethylene-propylene diene monomer (EPDM) rubber, nitrile rubber (NBR), styrene-butadiene rubber (SBR), butadiene rubber (BR), acrylonitrile-butadiene-styrene (ABS) rubber, isoprene rubber (IR), natural rubber (NR), chloroprene rubber (CR), butyl and halobutyl rubber (e.g., IIR, BIIR, CIIR), silicone rubber (e.g., Q, MQ, VMQ, PVMQ), blends of one or more of rubber materials (e.g., blend of SBR and BR), and blends of one or more rubber materials with a compatible resin, such as a blend of a rubber material (e.g., NBR) with polyvinyl chloride (PVC). In one embodiment, the closed-cell foam is ARMAFLEX® foam manufactured by Armacell, LLC. This material is a nitrile rubber-PVC blend having a thermal conductivity of about 0.25 BTU·in/hr·ft²·° F., a density of about 3 to 6 lbs/ft³, and good fire retardant properties.

The closed-cell foam used in the insulation assemblies described herein is not limited to rubber materials. The closed-cell foam can also be formed using other polymeric materials such as crosslinked or non-crosslinked polyethylene, polypropylene, polyethylene terephthalate, polyurethane, phenolic resins, polyvinyl chloride, poly(ethylene-co-vinyl-acetate), poly(ethylene-propylene-diene), polyamide, or blends thereof.

The closed-cell foam can also be a foamed ceramic. One example of a suitable cellular ceramic material is cellular glass formed by mixing pulverulent glass particles with a cellulating agent and forming a cellulatable glass batch as described in U.S. Pat. No. 3,354,024 to D'Eustachio et al., which is incorporated by reference herein. The formulated glass may comprise, for example, conventional borosilicate or soda lime glass in crushed cullet form and the cellulating agent may comprise a carbonaceous material such as carbon black and the like. Other suitable cellular ceramic materials formed of a cellulatable siliceous composition are disclosed in U.S. Pat. No. 3,441,396 to D'Eustachio et al. and U.S. Pat. No. 7,788,949 to Huston et al., both of which are also incorporated herein by reference.

A closed-cell foam typically has an open cell content of about 30% or less, preferably about 20% or less, more preferably about 10% or less, even more preferably about 5% or less, still more preferably about 2% or less, most preferably about 1% or less. The closed-cell foam can have an open cell content of essentially 0%. Open cell content can be measured according to ASTM method D6226-05. References directed to various foam insulation materials include U.S. Pat. Nos. 2,849,028 to Clark et al.; 4,053,439 to Chlystek; 4,245,055 to Smith; 4,122,045 to Garrett et al.; 6,245,267 to Kreiser et al.; 7,854,240 to Meller et al.; and 8,186,388 to Princell et al.; and U.S. Publication Nos. 2003/0213525 to Patel et al.; 2010/0071289 to Princell et al.; 2010/0305224 to Li et al.; 2010/0193061 to Princell et al.; and 2010/0179236 to Bosnyak et al., all of which are incorporated by reference herein.

Depending on the level of rigidity required for the trapezoidal insulation segments, different levels of compressive strength can be exhibited by the closed-cell foam. For example, in some embodiments the closed-cell foam should exhibit a relatively low degree of rigidity (i.e., a greater degree of flexibility) so that the trapezoidal insulation segments of the insulation assembly can accommodate expansion and contraction of the conduit or other structure on which the insulation assembly is installed. For example, the ARMAFLEX® foam noted herein exhibits sufficient flexibility for use in the trapezoidal insulation segments of the insulation assembly.

Use of a closed-cell foam to define the trapezoidal insulation segments 104 may substantially prevent absorption of water or other fluids within the trapezoidal insulation segments. As noted above, absorption of water may detrimentally affect the insulative properties of the insulation as well as damage the insulation and/or the conduit about which the insulation is wrapped. Accordingly, use of closed-cell insulation avoids many of the issues noted above with respect to infiltration of moisture into insulation.

The trapezoidal insulation segments 104 may be coupled to the jacket 102 in a variety of manners. In one example embodiment, thermal or ultrasonic welding may be employed to couple the trapezoidal insulation segments 104 to the jacket 102. In another embodiment an adhesive may be employed to couple the trapezoidal insulation segments 104 to the jacket 102. Suitable adhesives can be characterized as flowable adhesives, pressure-sensitive adhesives, contact-adhesives, hot melt adhesives, and the like. Various adhesive solvent systems can be used, including water-based adhesives and acrylic hydrocarbon solvent-based adhesives. Suitable adhesive materials include ARMAFLEX® 520 Adhesive or ARMAFLEX® Low VOC Spray Contact Adhesive available from Armacell, LLC.

In certain embodiments, the adhesive may give off substantially no volatiles. Solvent-based polymer adhesives can be applied and then heated to drive off the solvent volatiles. The volatiles can be reduced to a sufficiently low concentration so that there is substantially no volatile emission at room temperature. To achieve this, the adhesive may be heated for a sufficient time and at a sufficiently high temperature to reduce the volatile content of the adhesive to this level. The volatile content of the adhesive may be less than about 5% by weight of the adhesive, or even less than about 2% by weight of the adhesive. One adhesive which can be prepared so that it has this low of a concentration of volatiles is a self crosslinking acrylic polymer. The solvents used with the acrylic polymer adhesive may be selected from the group consisting of ethyl acetate, isopropanol, toluene, acetone, and mixtures thereof. The polymer may be heated during the curing step of adhesive preparation. While the acrylic is crosslinking, the adhesive mixture may be exposed to hot air at high velocity to remove the volatiles. Crosslinked acrylic polymer adhesive can be obtained commercially, such as from MACtac of Stow, Ohio.

In another embodiment the trapezoidal insulation segments 104 may comprise a material that is self adhesive, and hence a separate adhesive may not be needed to attach the trapezoidal insulation segments to the jacket 102. For example, the trapezoidal insulation segments 104 may comprise AP/ARMAFLEX® SA available from Armacell, LLC. Additional example embodiments of self-adhering materials are described in U.S. Pat. No. 5,971,034 to Heisey et al., which is incorporated by reference herein.

As further illustrated in FIG. 1, the trapezoidal insulation segments 104 may be attached to the jacket 102 such that notches 106 are defined between the trapezoidal insulation segments when the insulation assembly 100 is positioned in a planar configuration. The trapezoidal insulation segments 104 may be separate and independently attached to the jacket 102. Accordingly, the notches 106 may define gaps between the trapezoidal insulation segments 104. In some embodiments, the trapezoidal insulation segments 104 may be attached to the jacket 102 such that the trapezoidal insulation segments are in contact with adjacent trapezoidal insulation segments. By independently attaching each of the trapezoidal insulation segments 104 to the jacket 102, the insulation assembly 100 may be provided with additional flexibility as compared to embodiments in which the trapezoidal insulation segments are directly coupled to one another such that the insulation assembly may more closely conform to the shape of an item about which the insulation assembly is wrapped (e.g., a conduit).

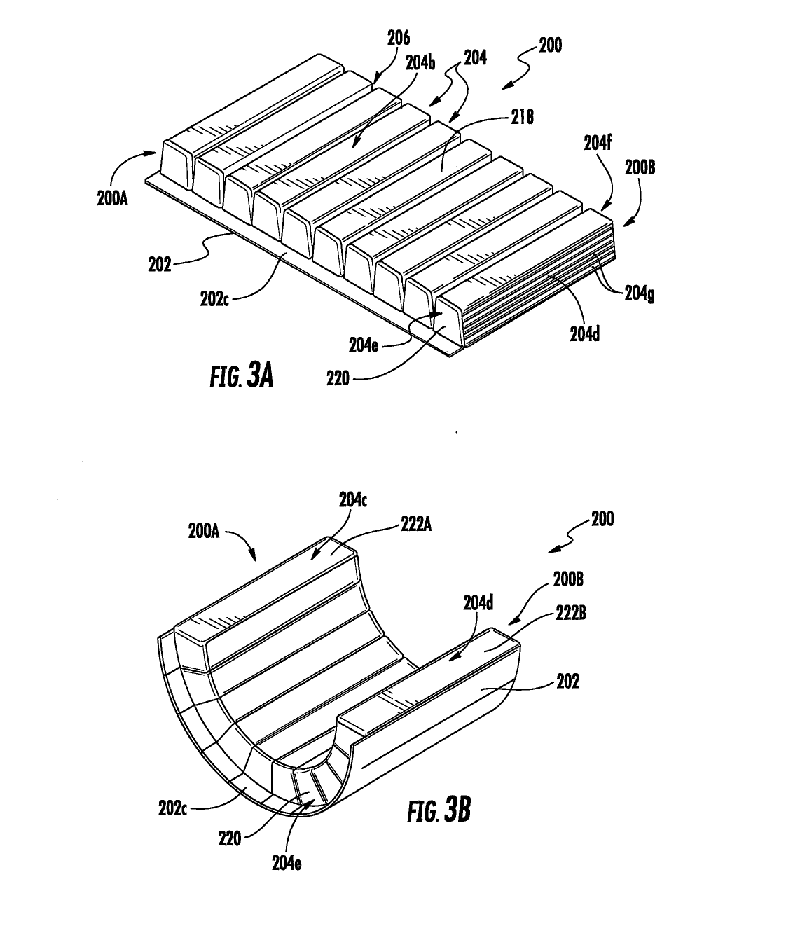

As further illustrated in FIG. 1, the trapezoidal insulation segments 104 may comprise a plurality of layers 104g. In this regard, as illustrated in FIG. 2, the trapezoidal insulation segments 104 may be formed by combining a plurality of sheets 108 of insulation material to form a stack 110. For example, the sheets 108 may comprise sheets of closed-cell foam such that the trapezoidal insulation segments 104 formed therefrom comprise layers 104g of the closed-cell foam. The sheets 108 of insulation material may be coupled to one another to form the stack 110. In this regard, the sheets 108 of insulation material may be coupled to one another in a variety of manners, including methods employing the various above-described examples of adhesives and other coupling methods.

After the sheets 108 of insulation material are coupled to one another, the stack 110 may be cut to form the trapezoidal insulation segments 104. In this regard, for example, in one embodiment the stack 110 may be cut along pairs of non-parallel lines 112, 114 to define a trapezoidal insulation segment 104′. Further, a cut along an additional line 116 may define an additional trapezoidal insulation segment 104″ which is initially upside down relative to the first trapezoidal insulation segment 104′. Additional cuts may be employed to form more trapezoidal insulation segments 104. In this regard, by cutting the stack 110 of sheets 108 of insulation material in this manner, very little insulation material may be wasted in the formation of the trapezoidal insulation segments 104 since the angled surfaces of two adjacent trapezoidal insulation segments may be formed by a single cut. However, in other embodiments the stack 110 may be cut in different manners to define the trapezoidal insulation segments 104. In one embodiment the trapezoidal insulation segments 104 may be formed by cutting along a first plurality of parallel lines (including, e.g., lines 112 and 116) and cutting along a second plurality of parallel lines (including, e.g., line 114), which are non-parallel to the first plurality of cutting lines. This cutting procedure may expedite production of the trapezoidal insulation segments 104, although various other embodiments of methods for forming the trapezoidal insulation segments may be employed.

As further illustrated in FIG. 2, the cuts employed to form the trapezoidal insulation segments 104 may extend in a direction such that the sheets 108, and hence the layers 104g, extend substantially parallel to the major end surface 104a and the minor end surface 104b. Further, forming the trapezoidal insulation segments 104 in this manner causes the layers 104g of the insulation material to extend substantially parallel to the first major surface 102a and the second major surface 102b of the jacket 102 when the trapezoidal insulation segments are coupled thereto. The layers 104g of the trapezoidal insulation segments 104 may be retained in this configuration due to adhesive placed therebetween, or the layers otherwise being secured together as noted above.

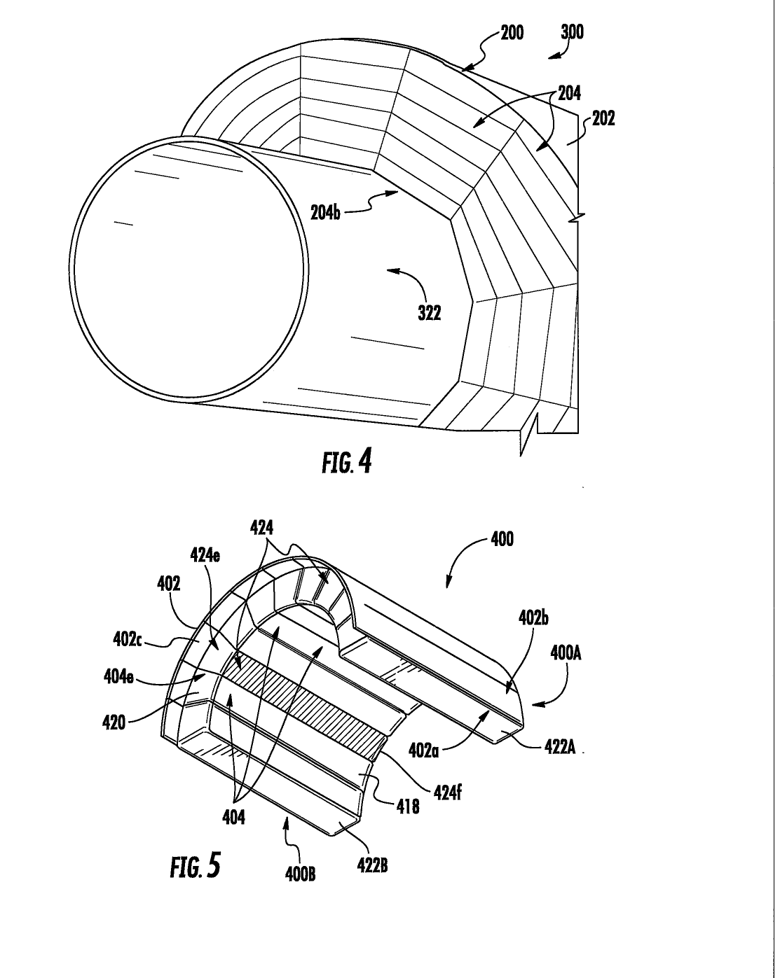

Embodiments of the insulation assemblies may include other features beyond those included in the insulation assembly 100 described above with respect to FIG. 1. In this regard, FIG. 3A illustrates a perspective view of a second embodiment of an insulation assembly 200. As illustrated, the insulation assembly 200 (and various later-referenced insulation assemblies) may include some or all of the features described above with respect to the embodiment of the insulation assembly 100 of FIG. 1, which are generally referenced with similar reference numerals.

Further, the insulation assembly 200 may include a slip layer 218 coupled to the minor end surface 204b of each of the trapezoidal insulation segments 204. The slip layer 218 may be configured to allow the insulation assembly 200 to easily slide over a conduit or other structure which is wrapped by the insulation. In this regard, by reducing the friction between the insulation assembly 200 and the conduit or other structure on which the insulation assembly is placed, an installer may more easily move the insulation assembly to a desired position. For example, the insulation assembly 200 may be relatively heavy when sized and employed to insulate relatively large conduits such as oil pipelines. Hence, by providing the slip layer 218 at the minor end surfaces 204b of the trapezoidal insulation segments 204, friction therebetween may be reduced such that the insulation assembly 200 may be more easily moved to a desired position.

In addition to defining a low friction surface, the slip layer 218 may also be configured to be cut and tear resistant. In this regard, when sliding the insulation assembly 200 across a conduit or other structure, sharp edges thereon may come into contact with the insulation assembly. For example, in one embodiment the insulation assembly 200 may be placed over an existing insulation assembly on a conduit in order to further insulate the conduit. The existing insulation assembly may include bolts, metal bands, or items configured to hold the existing insulation assembly in place, which may define sharp protrusions that might otherwise damage the minor end surfaces 204b of the trapezoidal insulation segments 204 without the slip layer 218.

Thus, as noted above, the slip layer 218 may define a low coefficient of friction and tear and cut resistance. In this regard, by way of example, the slip layer 218 may comprise a layer of material that is coupled to the minor end surfaces 204b of the trapezoidal insulation segments 204. Further, the slip layer 218 may be coupled to the minor end surfaces 204b through a variety of manners, including methods employing the various above-described examples of adhesives and other coupling methods. In another embodiment the slip layer 218 may comprise a material that is self adhesive, and hence a separate adhesive may not be needed to attach the slip layer to the minor end surfaces 204b of the trapezoidal insulation segments 204. In some embodiments the slip layer 218 may be attached to the trapezoidal insulation segments 204 after they are formed, such that only the minor end surfaces 204b thereof are covered when forming the trapezoidal insulation segments in an oppositely disposed manner, as described above with respect to FIG. 2.

In some embodiments the slip layer 218 may preferably define a static coefficient of friction (e.g., with respect to sheet metal) of less than about 0.3, less than about 0.25, or less than about 0.22. Further, in some embodiments the slip layer 218 may preferably define a kinetic coefficient of friction (e.g., with respect to sheet metal) of less than about 0.25, less than about 0.2, or less than about 0.17. These kinetic and static friction coefficients may be derived from testing in accordance with the ASTM D1894 sled test method for determining coefficients of friction. An example embodiment of the material defining the slip layer 218 includes the polyolefin family of polymers used in film manufacture.

In another embodiment the slip material 218 may comprise a fluid that is applied to the minor end surfaces 204b of the trapezoidal insulation segments 204. For example, the fluid may be sprayed on the minor end surfaces 204b, applied via a wick or brush, or the minor end surfaces may be immersed in the fluid. Example embodiments of a fluid slip layer 218 include synthetic and natural oil-based lubricants. In embodiments including a fluid slip layer 218, the fluid may be configured to be non-corrosive so as to avoid damaging the other materials defining the insulation assembly 100 and the conduits insulated by the insulation assembly, including any welding or brazing thereon. In an additional example embodiment, the slip material 218 may comprise a powder such as dry graphite, polytetrafluoroethylene (PTFE), molybdenum disulfide, tungsten disulfide, etc. Accordingly, the slip layer 218 may be provided in a variety of differing forms.

As further illustrated in FIG. 3A, the insulation assembly 200 may comprise a resilient joint member 220 coupled to the first longitudinal end surface 204e of each of the trapezoidal insulation segments 204. In other embodiments a resilient joint member may be additionally or alternatively coupled to each of the second longitudinal ends 204f of the trapezoidal insulation segments 204. The resilient joint members 220 positioned at one or both of the longitudinal ends 204e, 204f of the trapezoidal insulation segments 204 may be configured to contact an adjacent insulation assembly on the conduit or other structure insulated by the insulation assemblies. For example, the resilient joint members 220 at the first longitudinal ends 204e of the trapezoidal insulation segments 204 of a first insulation assembly 200 may contact the second longitudinal ends 204f (or a resilient joint member thereon) of the trapezoidal insulation segments 204 of a second insulation assembly. This pattern may be repeated with additional insulation assemblies 200 to cover the length of the conduit. In this regard, the resilient joint members 220 may act as expansion joints that allow for expansion and contraction of the insulation assemblies and/or the conduit. Thus, contact may be maintained between the insulation assemblies such that substantially the entire length of the conduit is insulated despite expansion and contraction.

The resilient joint members 220 may comprise open-cell foam in some embodiments. As used herein, “open-cell foam” refers to a foamed polymeric material having a higher percentage of open cells as compared to a closed-cell foam. Such materials typically provide a thermal conductivity level similar to closed cell foams, but exhibit a greater degree of flexibility and softness. In some embodiments, closed-cell foam may be defined as containing from about 3% to about 7% open cells, and open-cell foam may be defined as containing up to 40% closed cells. However, the open and closed cell content of the foams may vary in other embodiments.

Open-cell foams can be constructed of the same polymeric materials as closed-cell foams and are often manufactured by applying a mechanical or vacuum-assisted process to a closed-cell foam, resulting in crushing or bursting of a portion of the closed cells. U.S. Pat. No. 6,080,800 to Frey et al., which is incorporated by reference, describes a process for producing an open-cell foam. One example of a commercially available open-cell foam suitable for use in the present disclosure is AP COILFLEX™ conformable duct liner available from Armacell, LLC. Additional embodiments of open-cell foam suitable for use in the present disclosure are provided in U.S. Publication No. 2010/0212807 to Princell et al., and which is incorporated herein by reference.

As further illustrated in FIG. 3A, the jacket 202 may define a lip 202c that extends beyond one or both of the longitudinal end surfaces 204e, 204f of the trapezoidal insulation segments 204. In embodiments of the insulation assembly 200 comprising a resilient joint member 220, the lip 202c may also extend beyond the resilient joint member. The lip 202c may function to cover a portion of an adjacent insulation assembly when the insulation assemblies are wrapped around a conduit or other structure. Accordingly, the lip 202c may function to prevent water ingress between the insulation assemblies. In this regard, water infiltration into the resilient joint member 220 may be avoided.

Note that the insulation assemblies 100, 200 have been thus far been described and illustrated as defining a planar configuration (see, FIGS. 1 and 3A). This configuration may facilitate shipment of the insulation assemblies, since the insulation assemblies may be easily stacked in this configuration. However, as noted above, the insulation assemblies may be configured to wrap about a conduit or other structure. In this regard, by way of example, FIG. 3B illustrates the insulation assembly 200 of FIG. 3A in a curved configuration. As illustrated, when the insulation assembly 200 is curled inwardly, the notches 206 between the trapezoidal insulation segments 204 are decreased in size or eliminated completely.

In this regard, FIG. 4 illustrates an insulated conduit assembly 300 comprising the insulation assembly 200 of FIGS. 3A and 3B and a conduit 322 about which the insulation assembly is wrapped. As illustrated, use of insulation segments 204 defining a trapezoidal shape allows the insulation assembly 200 to substantially conform to the shape of the conduit 322 with the minor end surfaces 204b of each of the trapezoidal insulation segments facing the conduit. Further, the insulation assembly 200 may substantially avoid gaps in the insulation due to the trapezoidal insulation segments 204 coming into contact with one another. Thus, the insulative properties of the insulated conduit assembly 300 are improved.

In some embodiments the insulation assemblies may be configured to extend about a portion of a circumference of a conduit, as opposed to the whole circumference. In this regard, FIG. 3B illustrates the insulation assembly 200 in a curved configuration configured to cover one half of the circumference of a conduit. In this embodiment the insulation assembly may be wrapped around a half of a conduit (e.g., a top half), and a second insulation assembly may wrap around a second half of the conduit (e.g., a bottom half). However, in other embodiments the insulation assemblies may respectively cover a smaller portion of the circumference of a conduit, such that more than two insulation assemblies are employed to cover the circumference of the conduit. In another embodiment the insulation assembly may cover a larger portion of the circumference of a conduit. For example, in some embodiments a single insulation assembly may have a length sufficient to extend substantially completely around the circumference of a conduit such that a first longitudinal end 200A of the insulation assembly 200 may be positioned proximate a second longitudinal end 200B of the insulation assembly when wrapped around the conduit. In some embodiments the first longitudinal end 200A and the second longitudinal end 200B of the insulation assembly 200 may be positioned proximate the bottom of the conduit when wrapped thereon. In this regard, by configuring the insulation assembly 200 in this manner, the insulation assembly may cover the conduit without a joint at the top half of the conduit such that water ingress is resisted. Further, any water that manages to infiltrate the insulation assembly 200 may drain therefrom at the joint at the bottom of the insulation assembly.

FIG. 3B also illustrates that in some embodiments the insulation assembly 200 may comprise a resilient joint member 222A coupled to the first angled surface 204c of one of the trapezoidal insulation segments 204 at the first longitudinal end 200A of the insulation assembly. The insulation assembly 200 may additionally or alternatively include a resilient joint member 222B coupled to the second angled surface 204d of one of the trapezoidal insulation segments 204 at the second longitudinal end 200B of the insulation assembly. The resilient joint members 222A, 222B at the longitudinal ends 200A, 200B of the insulation assembly 200 may serve substantially the same function as the resilient joint members 220 coupled to the longitudinal ends 204e, 204f of the trapezoidal insulation segments 204. In order to allow for expansion and contraction, the resilient joint members 222A, 222B at the longitudinal ends 200A, 200B of the insulation assembly 200 may comprise open-cell foam, such as the embodiments of open-cell foam discussed above with respect to the resilient joint members 220 at the longitudinal ends 204e, 204f of the trapezoidal insulation segments 204.

However, rather than providing for expansion and contraction along the longitudinal axis of the conduit about which the insulation assembly 200 is wrapped, which is the function of the resilient joint members 220 at the longitudinal ends 204e, 204f of the trapezoidal insulation segments 204, the resilient joint members 222A, 222B provide for expansion and contraction of the insulation assembly about the circumference of the conduit. In embodiments wherein a single insulation assembly 200 extends around the circumference of the conduit, the resilient joint member(s) 222A, 222B may be compressed between the two longitudinal ends 200A, 200B of the insulation assembly 200. Conversely, in embodiments in which multiple insulation assemblies 200 are employed to extend around the circumference of the conduit, the resilient joint member(s) 222A, 222B may be compressed between the longitudinal ends 200A, 200B of adjacent pairs of the insulation assemblies.

In some embodiments the jacket 202 may define a lip that extends past the first angled surface 204c of one of the trapezoidal insulation segments 204 at the first longitudinal end 200A of the insulation assembly and/or a lip that extends past the second angled surface 204d of one of the trapezoidal insulation segments 204 at the second longitudinal end 200B of the insulation assembly. For example, the lip(s) may extend past one or both of the resilient joint members 222A, 222B at the longitudinal ends 200A, 200B of the insulation assembly 200. Accordingly, the lip(s) at the longitudinal end(s) 200A, 200B of the insulation assembly may protect the resilient joint members 222A, 222B in substantially the same manner discussed above with respect to the lip 202c by reducing the likelihood of water ingress at the longitudinal ends of the insulation assembly.

In some embodiments the insulation assemblies may include additional or alternative features configured to facilitate use thereof in insulating a conduit or other structure. For example, as illustrated in FIG. 5, an insulation assembly 400 may comprise one or more trapezoidal load-bearing segments 424. In the illustrated embodiment, the insulation assembly includes two trapezoidal load-bearing segments 424, and the remainder of the trapezoidal members are trapezoidal insulation segments 404. The trapezoidal load-bearing segments 424 may be substantially similar in size and shape to the trapezoidal insulation segments 404 in some embodiments. Further, the trapezoidal load-bearing segments 424 may be coupled to the first major surface 402a of the jacket 402, for example via one of the above-described methods for coupling the trapezoidal insulation segments 404 to the jacket. The trapezoidal load-bearing segments 424 may include other features described above with respect to the trapezoidal insulation segments 404. For example, the resilient joint members 420 may be coupled to one or both of the longitudinal ends 424e, 424f of the trapezoidal load-bearing segments 424. By way of further example, resilient joint members 422A, 422B may be coupled to angled surfaces of the trapezoidal load-bearding segments 424 in embodiments in which the trapezoidal load-bearding segments are positioned at the longitudinal ends 400A, 400B of the insulation assembly 400.

The trapezoidal load-bearing segments 424 may be relatively more rigid than the trapezoidal insulation segments 404. In this regard, the trapezoidal load-bearing segments 424 may be configured to bear at least a portion of a load applied to the insulation assembly 400. For example, as noted above, the insulation assembly 400 may be relatively heavy in some embodiments, and the weight of the insulation assembly may compress the trapezoidal insulation segments 404 at the top of the insulation assembly. In order to ensure that the trapezoidal insulation segments 404 are not compressed to an extent that harms the insulative properties thereof, the trapezoidal load-bearing segments 424 may bear a portion of the load on the insulating assembly 400. Thus, for example, the trapezoidal load-bearing segments 424 may be provided at positions that are spaced substantially forty-five degrees from a zero degree position at the top of the conduit on which the insulation assembly is wrapped.

Further, in some embodiments attachment mechanisms employed to couple the insulation assembly 400 to a conduit (e.g., band straps, etc.) may apply pressure to the insulation assembly around the circumference thereof. Thus, trapezoidal load-bearing segments 424 may also be provided in the insulation assemblies 400 at positions around the remainder of the circumference of the conduit. Thus, for example, the trapezoidal load-bearing segments 424 may also be provided at positions that are spaced substantially forty-five degrees from a 180 degree position at the bottom of the conduit on which the insulation assembly is wrapped. However, the trapezoidal load-bearing segments 424 may be positioned in other places, preferably evenly distributed with at least one trapezoidal insulation segment 404 positioned between each pair of trapezoidal load-bearing segments.

In some embodiments the trapezoidal load-bearing segments 424 may comprise closed-cell foam. However, as noted above, the trapezoidal load-bearing segments 424 may be configured to be relatively more rigid than the trapezoidal insulation segments 404. For example, closed-cell foams employed in the trapezoidal insulation segments 404 and the trapezoidal load-bearing segments 424 may have a compressive strength from about 5 psi to about 200 psi, and more particularly from about 20 psi to about 150 psi. In this regard, the trapezoidal insulation segments 404 may define compressive strengths at the lower end of the above-noted ranges, and the trapezoidal load-bearing segments 424 may define compressive strengths at the upper end of the above-noted ranges in some embodiments. More broadly, the trapezoidal load-bearing segments 424 may define a greater compressive strength than the trapezoidal insulation segments 404. A commercially available example of a rigid closed-cell foam is HT-300® polyisocyanurate foam available from HiTHERM®, LLC.

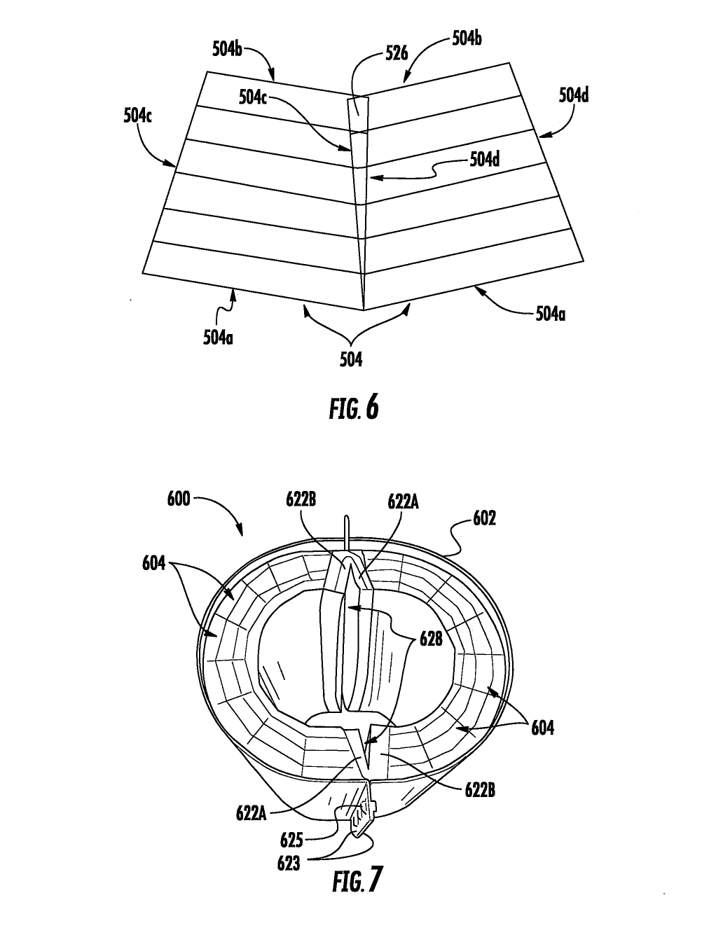

Further, as illustrated in FIG. 6, in some embodiments the angles defined by the angled surfaces 504c, 504d of the trapezoidal insulation segments 504 (and/or the trapezoidal load-bearing segments) may be configured such that the trapezoidal insulation segments are compressed more proximate the minor end surface 504b than proximate the major end surface 504a. In this regard, a compression zone 526 is defined when the trapezoidal insulation segments 504 are brought into contact with one another. The angles of the angled surfaces 504c, 504d when the major end surface 504a and the minor end surface 504b are oriented horizontally may be from about 0 degrees to about 45 degrees and more particularly from about 0 degrees to about 20 degrees relative to vertical in some embodiments.

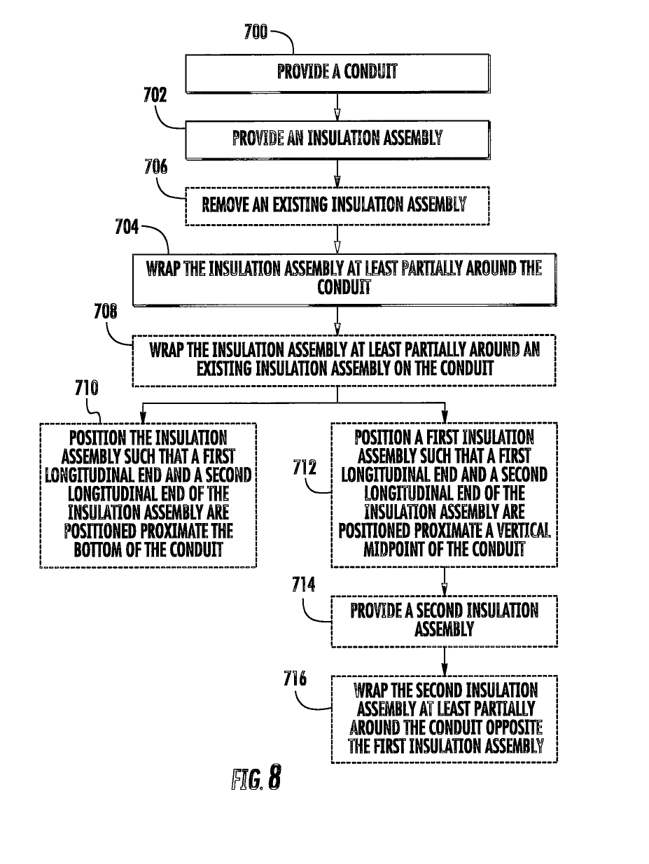

By forming a compression zone 526 in which the trapezoidal insulation segments 504 are compressed more proximate the minor end surface 504b than proximate the major end surface 504a, issues with respect to the trapezoidal insulation segments (and/or the trapezoidal load-bearing segments coming out of contact with one another may be avoided. In this regard, as illustrated in FIG. 7, in embodiments of an insulation assembly 600 in which the trapezoidal insulation segments 604 are configured to define a perfect circle, the trapezoidal insulation segments (or the resilient joint members 622A, 622B) may come out of contact with another. For example, extreme cold may cause contraction of the insulation assembly 600, which may cause gaps 628 to form in the insulation assembly that may reduce the ability of the insulation assembly to insulate a conduit.

Note that embodiments of the insulation assemblies discussed herein may be attached to conduits to form insulated conduit assemblies via a variety of methods. For example, in one embodiment bands may be placed around the insulation assemblies and tensioned. In an example embodiment, as illustrated in FIG. 7, the longitudinal ends of the insulation assemblies 600 define flanges 623 that are coupled together via fasteners 625 such as rivets, bolts, or screws. The flanges 623 may be defined by the jacket 602 in some embodiments. However, various other attachment mechanisms may be employed in other embodiments.

FIG. 8 illustrates an embodiment of a method for insulating a conduit. As illustrated, the method may include providing a conduit at operation 700 and providing an insulation assembly at operation 702. The insulation assembly may comprise, for example, any one of the above-described embodiments of the insulation assembly. The method may further comprise wrapping the insulation assembly at least partially around the conduit at operation 704. In one embodiment the minor end surface of each of the trapezoidal insulation segments faces the conduit and each of the trapezoidal insulation segments is compressed more proximate the minor end surface than proximate the major end surface.

Additional optional operations are illustrated in dashed boxes. In this regard, in some embodiments the method may further comprise removing an existing insulation assembly from the conduit at operation 706 prior to wrapping the insulation assembly at least partially around the conduit at operation 704. In an alternate embodiment, wrapping the insulation assembly at least partially around the conduit at operation 704 may comprise wrapping the insulation assembly at least partially around an existing insulation assembly on the conduit at operation 708.

Further, wrapping the insulation assembly at least partially around the conduit at operation 704 may comprise positioning the insulation assembly such that a first longitudinal end and a second longitudinal end of the insulation assembly are positioned proximate the bottom of the conduit at operation 710. In another embodiment the method may further comprise providing a second insulation assembly at operation 714, which may comprise one of the above-described embodiments of insulation assemblies, and wrapping the second insulation assembly at least partially around the conduit opposite the insulation assembly at operation 716. In this regard, in some embodiments wrapping the insulation assembly at least partially around the conduit at operation 704 may comprise positioning the insulation assembly such that a first longitudinal end and a second longitudinal end of the first insulation assembly are positioned proximate a vertical midpoint of the conduit 712.

Many modifications and other embodiments of the disclosure will come to mind to one skilled in the art to which this disclosure pertains having the benefit of the teachings presented in the foregoing description; and it will be apparent to those skilled in the art that variations and modifications of the present disclosure can be made without departing from the scope or spirit of the disclosure. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An insulation assembly, comprising:
a jacket defining a first major surface and a second major surface;
a plurality of trapezoidal insulation segments respectively defining a major end surface, a minor end surface, a first angled surface and a second angled surface extending between the major end surface and the minor end surface, a first longitudinal end surface and a second longitudinal end surface; and
a slip layer coupled to the minor end surface of each of the trapezoidal insulation segments,
wherein the major end surface of each of the trapezoidal insulation segments is coupled to the first major surface of the jacket.

2. The insulation assembly of claim 1, wherein the slip layer comprises a polyolefin.

3. The insulation assembly of claim 1, wherein the jacket comprises sheet metal or fiber reinforced polymer.

4. The insulation assembly of claim 1, wherein the trapezoidal insulation segments comprise closed-cell foam.

5. The insulation assembly of claim 4, wherein the trapezoidal insulation segments comprise a plurality of layers of the closed-cell foam.

6. The insulation assembly of claim 5, wherein the layers extend substantially parallel to the first major surface and the second major surface of the jacket.

7. The insulation assembly of claim 5, further comprising an adhesive between the layers of the closed-cell foam.

8. The insulation assembly of claim 1, further comprising an adhesive between the jacket and the trapezoidal insulation segments.

9. The insulation assembly of claim 1, further comprising a resilient joint member coupled to the first longitudinal end surface of each of the trapezoidal insulation segments.

10. The insulation assembly of claim 9, wherein the resilient joint member comprises open-cell foam.

11. The insulation assembly of claim 9, wherein the jacket defines a lip that extends beyond the resilient joint member.

12. The insulation assembly of claim 1, further comprising a resilient joint member coupled to the first angled surface of one of the trapezoidal insulation segments at a longitudinal end of the insulation assembly.

13. The insulation assembly of claim 12, wherein the resilient joint member comprises open-cell foam.

14. The insulation assembly of claim 1, further comprising one or more trapezoidal load-bearing segments that are relatively more rigid than the trapezoidal insulation segments and configured to bear at least a portion of a load applied to the insulation assembly,
wherein the trapezoidal load-bearing segments are coupled to the first major surface of the jacket.

15. The insulation assembly of claim 14, wherein the trapezoidal load-bearing segments are spaced between the trapezoidal insulation segments.

16. An insulation assembly, comprising:
a jacket defining a first major surface and a second major surface;
a plurality of trapezoidal insulation segments respectively defining a major end surface, a minor end surface, a first angled surface and a second angled surface extending between the major end surface and the minor end surface, a first longitudinal end surface and a second longitudinal end surface; and
one or more trapezoidal load-bearing segments that are relatively more rigid than the trapezoidal insulation segments and configured to bear at least a portion of a load applied to the insulation assembly,
wherein the major end surface of each of the trapezoidal insulation segments is coupled to the first major surface of the jacket, and
wherein the trapezoidal load-bearing segments are coupled to the first major surface of the jacket.

17. The insulation assembly of claim 16, wherein the jacket comprises sheet metal or fiber-reinforced polymer.

18. The insulation assembly of claim 16, wherein the trapezoidal insulation segments comprise closed-cell foam.

19. The insulation assembly of claim 18, wherein the trapezoidal insulation segments comprise a plurality of layers of the closed-cell foam.

20. The insulation assembly of claim 19, wherein the layers extend substantially parallel to the first major surface and the second major surface of the jacket.

21. The insulation assembly of claim 19, further comprising an adhesive between the layers of the closed-cell foam.

22. The insulation assembly of claim 16, further comprising an adhesive between the jacket and the trapezoidal insulation segments and between the jacket and the trapezoidal load-bearing segments.

23. The insulation assembly of claim 16, further comprising a resilient joint member coupled to the first longitudinal end surface of each of the trapezoidal insulation segments and a first longitudinal end surface of each of the trapezoidal load-bearing segments.

24. The insulation assembly of claim 23, wherein the resilient joint member comprises open-cell foam.

25. The insulation assembly of claim 23, wherein the jacket defines a lip that extends beyond the resilient joint member.

26. The insulation assembly of claim 16, further comprising a resilient joint member coupled to the first angled surface of one of the trapezoidal insulation segments at a longitudinal end of the insulation assembly.

27. The insulation assembly of claim 26, wherein the resilient joint member comprises open-cell foam.

28. The insulation assembly of claim 16, wherein the trapezoidal load-bearing segments are spaced between the trapezoidal insulation segments.

29. An insulated conduit assembly, comprising:
a conduit; and
an insulation assembly wrapped at least partially around the conduit, the insulation assembly comprising:
a jacket defining a first major surface and a second major surface; and
a plurality of trapezoidal insulation segments respectively defining a major end surface, a minor end surface, a first angled surface and a second angled surface extending between the major end surface and the minor end surface, a first longitudinal end surface and a second longitudinal end surface,
wherein the major end surface of each of the trapezoidal insulation segments is coupled to the first major surface of the jacket,
wherein the minor end surface of each of the trapezoidal insulation segments faces the conduit, and
wherein the first angled surface and the second angled surface are configured such that the trapezoidal insulation segments are compressed more proximate the minor end surface than proximate the major end surface.

30. The insulated conduit assembly of claim 29, wherein the insulation assembly extends substantially completely around the conduit such that a first longitudinal end of the insulation assembly is positioned proximate a second longitudinal end of the insulation assembly.

31. The insulated conduit assembly of claim 29, wherein the first longitudinal end and the second longitudinal end of the insulation assembly are positioned proximate the bottom of the conduit.

32. The insulated conduit assembly of claim 29, further comprising a second insulation assembly,
wherein the insulation assembly wraps around a top half of the conduit and the second insulation assembly wraps around a bottom half of the conduit.

33. The insulated conduit assembly of claim 29, wherein the insulation assembly further comprises a slip layer coupled to the minor end surface of each of the trapezoidal insulation segments.

34. The insulated conduit assembly of claim 29, wherein the insulation assembly further comprises one or more trapezoidal load-bearing segments that are relatively more rigid than the trapezoidal insulation segments and configured to bear at least a portion of a load applied the insulation assembly, and
wherein the trapezoidal load-bearing segments are coupled to the first major surface of the jacket.

35. A method for insulating a conduit, comprising:
providing a conduit;
providing an insulation assembly, comprising:
a jacket defining a first major surface and a second major surface; and
a plurality of trapezoidal insulation segments respectively defining a major end surface, a minor end surface, a first angled surface and a second angled surface extending between the major end surface and the minor end surface, a first longitudinal end surface and a second longitudinal end surface,
wherein the major end surface of each of the trapezoidal insulation segments is coupled to the first major surface of the jacket; and
wrapping the insulation assembly at least partially around the conduit such that the minor end surface of each of the trapezoidal insulation segments faces the conduit and each of the trapezoidal insulation segments is compressed more proximate the minor end surface than proximate the major end surface.

36. The method of claim 35, wherein wrapping the insulation assembly at least partially around the conduit comprises positioning the insulation assembly such that a first longitudinal end and a second longitudinal end of the insulation assembly are positioned proximate the bottom of the conduit.

37. The method of claim 35, wherein wrapping the insulation assembly at least partially around the conduit comprises positioning the insulation assembly such that a first longitudinal end and a second longitudinal end of the insulation assembly are positioned proximate a vertical midpoint of the conduit.

38. The method of claim 37, further comprising providing a second insulation assembly; and
wrapping the second insulation assembly at least partially around the conduit opposite the insulation assembly.

39. The method of claim 35, further comprise removing an existing insulation assembly from the conduit prior to wrapping the insulation assembly at least partially around the conduit.

40. The method of claim 35, wherein wrapping the insulation assembly at least partially around the conduit comprises wrapping the insulation assembly at least partially around an existing insulation assembly on the conduit.
